(19) United States
(12) Patent Application Publication
(10) Pub. No.: US 2004/0001518 A1
(43) Pub. Date: Jan. 1, 2004

(54) System and method for emulating ringback transparently

(75) Inventors: Leroy Edwin Gilbert, Wellington, FL (US); Robert Callaghan, Prescott, AZ (US)

Correspondence Address: Elsa Keller, Intellectual Property Department, Siemens Corporation, 186 Wood Avenue South, Iselin, NJ, 08830, US

(73) Assignees: Siemens Information; Communication Networks, Inc.

(21) Appl. No.: 10/185,079

(22) Filed: Jun. 28, 2002

(51) Int. Cl. H04J 3/12; H04L 12/66; H04J 3/16

(52) U.S. Cl. 370/525; 370/352; 370/468

(57) ABSTRACT

A system and method is presented for providing a ringback tone at the initiating end of a call while substantially reducing bandwidth usage. The initiating end initiates a call through a network. The receiving end of the call responds by transmitting an alerting message containing information on the characterization of a ringback tone to the initiating end of the call. At the initiating end of the call, the proper ringback tone is determined based on this information, and a ringback tone is generated. When the call is picked up at the receiving end, a transmission to the initiating end alerts the initiating end to cease the ringback tone. Silence suppression may be used at the receiving end to prevent the transmission of an audio stream before the terminal (e.g., a phone) is picked at the receiving end.

### BACKGROUND OF THE INVENTION

1. Field of the Invention

The present invention relates to providing a destination generated tone (for example a ringback tone) over a network. More particularly, the present invention relates to providing to the initiator of a call a ringing tone while using substantially less bandwidth than a voice connection.

2. Description of Related Art

Ever since people started implementing telephone networks, there has been a need for the initiator of a telephone call to alert the recipient of a call that communication was desired. In the early years of telephone networks, the initiator of a call would have to turn a hand crank to generate enough alternating current to alert an operator, who would then ring the destination phone or another operator closer to the destination phone. Thus, the signal initializing the ring originated with the caller and traveled through the same two wires used to carry voice signals once the recipient of the call picked up the receiver. Long since telephone network switchboards went from being manually operated by legions of telephone operators to automatic machinery, the ringing telephone has remained.

As telephone networks matured, the source of the ringing signal shifted its proximity away from the caller and to the receiving end of a telephone call, since it is more efficient to send a ringing current from a switchboard that is close to the ringing phone than to send the signal through many miles of wire. However, it was necessary to inform the initiator of the call that the telephone at the remote end of the line was ringing. Thus, a switchboard proximate to the recipient would send an electrical signal back to the caller to create an audible ringing tone, also called “ringback”, with a cadence sounding much like a ringing telephone.

Though telephone networks have evolved and ringback is no longer necessary in most circumstances, telephone users have grown accustomed to hearing the ringing sound of a telephone while initiating a call, to the point where some users still believe (at least on a subconscious level) that they are actually hearing the ringing of the telephone at the other end. Moreover, there are other circumstances where a tone or other audible signal generated from the destination end of a connection is desirable, such as a destination specific error message or progress indication.

Preconnection tones such as ringback convey useful information. For example, a caller in the United States who often calls the United Kingdom will expect to hear a certain type of ringback, one that is approximately 0.4 second on, 0.2 seconds off, 0.4 seconds on again, and 2 seconds off before repeating the cycle. If the caller instead hears a ringback that is closer to 2 seconds on and 4 seconds off, the caller will realize that perhaps he or she has misdialed and is calling a more local phone instead. The caller can hang up before the person at the receiving end picks up, saving the caller the expense of a completed call and perhaps also a bit of embarrassment.

In traditional networks, the ringback signal originates near the recipient and travels over an already established voice path, using up the same bandwidth as an ongoing conversation. There are reasons that ringback has been implemented in this way. One reason is that it is important that the ringback tone be turned off as soon as the recipient picks up the phone, to prevent the caller from missing the first few words spoken by the recipient. Ideally, the caller will clearly hear the recipient say “hello”, thereby helping the caller to identify the recipient (which can be useful, for example, if several people living in a household share a single phone) or to determine the recipient's mood (also important in many situations) before responding. Another reason for the ringback signal to originate near the recipient is that the ringback tone itself can convey useful information, such as the destination country, as discussed above.

Disadvantageously, the traditional ringback method consumes a relatively large bandwidth for the little information (usually one or two tones played in repeating cycles) being conveyed. When all the ringing is added up and compared to the number and duration of calls actually completed, the network bandwidth of the ringback that occurs may effectively increase the average cost of a call by a few percent.

One solution to avoid this cost is the complete elimination of the ringback tone. One disadvantage of this solution is that callers usually expect a ringback tone and may believe the network is not working properly in its absence. Another disadvantage is that no information about the recipient (such as the country being called) is conveyed.

Another solution is the generation of a “pseudo-ringback” tone automatically proximate to the calling (initiating) party. One disadvantage of this solution is that when the called (recipient) party answers, the pseudo-ringback tone must be terminated and the voice connection established. To accomplish this, a signal must be sent from the answering party to the calling party, informing the source of the pseudo-ringback tone proximate to the calling party to stop the tone. Due to delays in many networks, this cannot be done quickly enough to prevent the first word or words of the called party from being lost. Another disadvantage is that, as with the complete elimination of the ringback tone, no information about the recipient is conveyed.

### SUMMARY OF THE INVENTION

It is therefore an object of the invention to provide a system and method for providing a ringback tone that requires substantially less bandwidth than a voice connection.

It is another object of the invention to provide a system and method for conveying information about a recipient to the initiator of a call using substantially less bandwidth than a voice connection.

It is yet another object of the invention to provide a system and method for providing a low-bandwidth ringback tone to the initiator of a call without substantially interfering with the start of a voice connection.

It is yet another object of the invention to provide a system and method for transmitting a tone description from the receiving end of a call to the initiating end of the call to permit generation of the appropriate ringback tone.

It is yet another object of the invention to provide a smooth fast transition from tone to human voice.

It is yet another object of the invention to use the arrival of voice packets from the receiving end of a call to trigger the termination of a ringback tone that uses substantially less bandwidth than a voice connection.

When a user at the initiating end of a call wishes to call a recipient, an alerting message, with information on the characterization of a ringback tone, originates at the receiving end of the call and is sent to the initiating end. A path between the recipient and initiator is logically established. Since many modem networks use some form of statictical multiplexing or packetized voice for transmission (for example, voice over IP/Internet or frame relay)), this connection can often be established with silence suppression enabled, so that no bandwidth is initially consumed even though a logical connection is established. At the initiating (calling) end, the received information on the characterization of a ringback tone is used to generate a ringback tone for the benefit of the initiating party. This tone typically reflects the customs / preferences of the destination party and locale.

At the initiating end, audio processing is used to merge the locally generated ringback tone with the audio stream from the receiving end. With silence suppression enabled, the audio stream is initially null.

When the recipient answers (e.g., by a telephone being picked up), an answer signal is transmitted from the receiving end to the initiating end, which will typically initiate call charging. Standard call signaling methods may be used for this answer signal. When the called party at the receiving end starts to speak, silence suppression on the connection (if active) automatically deactivates. Voice packets are sent from the receiving end to the initiating end. Depending on the configuration of the connection, silence suppression may be again applied to decrease the average bandwidth being used for the duration of the call (e.g. when a party to the call makes a pause in conversation).

Different methods may be used advantageously to assist the party at the initiating end to hear the first speech fragment of the recipient, even if the answer signal is delayed. First, the arrival of speech packets may serve as an early warning of a call answer, and the ringback tones may automatically cease even before the answer signal is received at the initiating end. As another example, the merge feature described above advantageously allows a party at the initiating end to hear the receiving end even if the ringback has not ceased. Another means to improve communication before ringback has ceased is for the ringback to automatically decrease in volume over time (e.g., the first iteration of the ringback tone is played at a high volume and subsequent iterations at a lower volume).

### BRIEF DESCRIPTION OF THE DRAWINGS

FIG. 1 is a diagram representing an example of a telephone network connecting two terminals.

FIG. 2A is a flow diagram of a process used to connect a first terminal to a second terminal, prior to pickup of the second terminal, in accordance with a preferred embodiment of the invention.

FIG. 2B is a flow diagram of a process used to connect a first terminal to a second terminal, subsequent to pickup of the second terminal, in accordance with a preferred embodiment of the invention.

### DETAILED DESCRIPTION

In a preferred embodiment, the invention is described in an implementation based on VoIP (voice over IP) telephone networks. In alternative preferred embodiments, the invention is implemented over other types of telephone networks that allow the bandwidth of a connection to be varied and/or allow a connection to be maintained even when a voice channel is not being utilized for that connection.

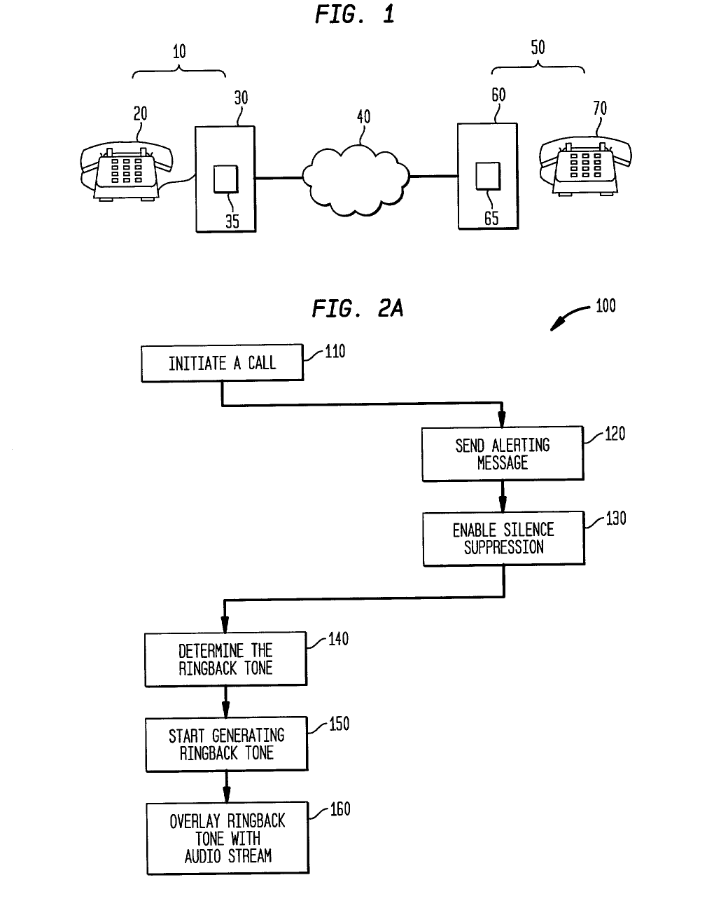

With reference to FIG. 1, a diagram of a telephone network connecting two ends is shown. Initiating end 10, which in a preferred embodiment is a local telephone network with a plurality of terminals, comprises terminal 20 and protocol converter 30, which has a connection for communicating with terminal 20. Initiating end 10 has a connection for communication with network 40. Receiving end 50, which in a preferred embodiment is a local telephone network with a plurality of terminals, comprises protocol converter 60 and terminal 70. Receiving end 50 has a connection for communication with network 40, and protocol converter 60 has a connection for communication with terminal 70.

In a preferred embodiment, terminal 20 and terminal 70 are landline telephones, though in alternative preferred embodiments terminal 20 and/or terminal 70 may be other types of terminals, such as fax machines, cell phones, or modems, by example only. In a preferred embodiment, protocol converter 30 and protocol converter 60 are telephone network servers, though in alternative preferred embodiments protocol converter 30 and/or protocol converter 60 may be other types of protocol converters, such as PBX stations, or network switches, by example only. Finally, in a preferred embodiment network 40 is the Internet, though in alternative preferred embodiments network 40 is a data network, a public telephone network, or a private telephone network or a combination thereof. The equipment used in these preferred embodiments are known to those with skill in the art of telephone and data networks.

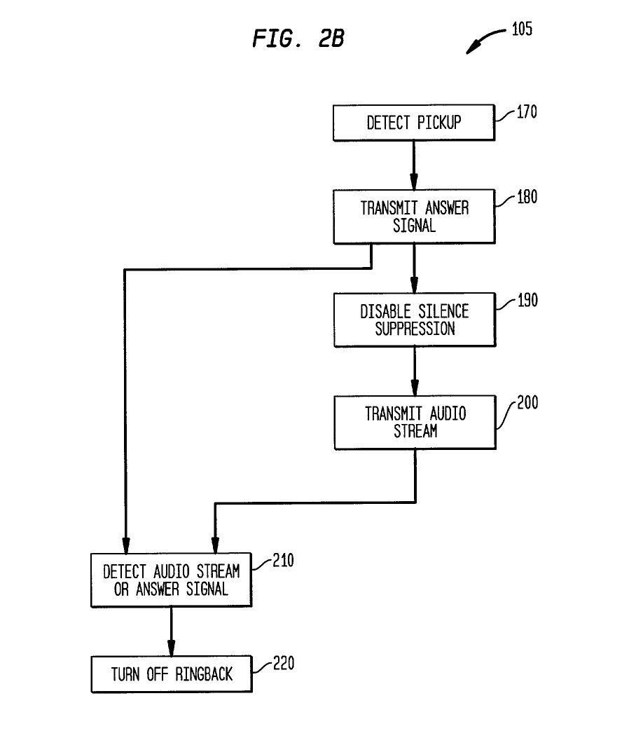

A user at terminal 20 wishes to communicate with another party, who is at terminal 70. With reference to the flow diagram 100 in FIG. 2A, once the destination information (e.g., the telephone number of the desired party) is provided, initiating end 10 initiates a call 110 through network 40 to receiving end 50. Receiving end 50 responds by sending an alerting message 120, with information on the characterization of a ringback tone (e.g. frequency and duration of tones and duration of pauses) through network 40 to initiating end 10. In a preferred embodiment, the information characterizes a ringback tone associated with the geographic location of terminal 20. A path between initiating end 10 and receiving end 50 is logically established over network 40. In a preferred embodiment, receiving end 50 contains a silence suppression device 65 that enables silence suppression 130 to reduce the bandwidth occupied by this path to zero.

Initiating end 10, after receiving the identifying information that receiving end 50 had sent in alerting message 120 determines the characterization of ringback tone 140 based on the identifying information and starts generating a ringback tone 150 at terminal 20. In a preferred embodiment, a simple audio processing device 35 in protocol converter 30 merges or overlays 160 the locally generated ringback tone 150 with any audio stream that may be received from receiving end 50 (see transmission of audio stream 200 below). In a preferred embodiment initially, while receiving end 50 enables silence suppression 130, the audio stream is null.

With reference to the flow diagram 105 in FIG. 2B, upon the detection of a pickup 170 at terminal 70 (e.g., a telephone receiver being taken off its hook), receiving end 50 transmits an answer signal 180 to initiating end 10. In a preferred embodiment, standard call signaling methods are used for this answer signal. When terminal 70 receives a local audio signal (e.g. the party at terminal 70 starts speaking) and converts it to an electrical signal, receiving end 50 disables silence suppression 190 and starts transmitting an audio stream 200 based on the electrical signal. In a preferred embodiment, the transmission of audio stream 200 is the transmission of audio packets. At initiation end 10 the detection 210 of either the audio stream transmission 200 or the answer signal transmission 180 may be used to turn off the ringback 220.

In a preferred embodiment, the starting of generating a ringback tone 150 causes a first ringback tone that is played at a high volume and subsequent iterations of the ringback tone are at a lower volume.

In a preferred embodiment, during the call silence suppression may be enabled by either initiating end 10 or receiving end 50 or both to decrease the average bandwidth being used for the duration of the call (e.g. when a party to the call makes a pause in conversation).

While the invention has been described in terms of preferred embodiments, those skilled in the art will recognize that the invention can be practiced with modification within the spirit and scope of the appended claims.

We claim:

1. A method for providing a ringback tone at a terminal, comprising:
a) initiating a call over a network;
b) receiving an alerting message comprising information on the characterization of the ringback tone;
c) determining the characterization of the ringback tone based on said information; and
d) prompting said terminal to generate said ringback tone based on said determination.

2. The method for providing a ringback tone at a terminal of claim 1, further comprising:
merging said ringback tone with an audio stream.

3. The method for providing a ringback tone at a terminal of claim 1, further comprising:
detecting an audio stream; and
causing said ringback to cease upon said detection of said audio stream.

4. The method for providing a ringback tone at a terminal of claim 1, further comprising:
detecting an answer signal; and
causing said ringback to cease upon said detection of said answer signal.

5. The method for providing a ringback tone at a terminal of claim 1, wherein said generating said ringback tone is generating a plurality of iterations of said ringback tone and wherein the first of said plurality of iterations has a greater volume than subsequent of said plurality of iterations.

6. The method for providing a ringback tone at a terminal of claim 1, wherein said ringback tone is associated with the geographical location of the source of said alerting message.

7. The method for providing a ringback tone at a terminal of claim 1, wherein the network bandwidth utilized by said ringback subsequent to said receiving an alerting message is about zero.

8. A method for conveying ringback information over a network while utilizing substantially less bandwidth than a voice connection, comprising the steps of:
a) sending an alerting message over a network in response to the receipt of call over said network, wherein said alerting message comprises information on the characterization of the ringback tone;
b) detecting pickup at a terminal; and
c) transmitting an answer signal over said network upon said detection of said pickup.

9. The method for conveying ringback information over a network while utilizing substantially less bandwidth than a voice connection of claim 8, further comprising the step of enabling silence suppression at least during a period of time prior to said detection of said pickup.

10. The method for conveying ringback information over a network while utilizing substantially less bandwidth than a voice connection of claim 9, further comprising the step of disabling silence suppression subsequent to said detection of said pickup.

11. The method for conveying ringback information over a network while utilizing substantially less bandwidth than a voice connection of claim 8, further comprising the step of transmitting an audio stream over said network.

12. The method for conveying ringback information over a network while utilizing substantially less bandwidth than a voice connection of claim 11, wherein said transmitting an audio stream over said network comprises transmitting voice packets.

13. The method for conveying ringback information over a network while utilizing substantially less bandwidth than a voice connection of claim 8, wherein said ringback tone is associated with the geographical location of the said terminal.

14. A protocol converter comprising:
a connection to a terminal, wherein the terminal accepts input for destination information and is capable of generating a ringback tone; and
a server for receiving said destination information from said terminal through said connection and initiating a call over a network and for determining the characterization of the ringback tone and prompting said terminal to generate said ringback tone upon receiving, in response to said initiation of said call, information on said characterization of said ringback tone,
wherein said information on said characterization of said ringback tone comprises information on the frequency and duration of tones and duration of pauses.

15. The protocol converter of claim 14, wherein said protocol converter detects an audio stream and causes said ringback tone to cease upon said detection of said audio stream.

16. The protocol converter of claim 14, wherein the bandwidth utilized by said ringback tone over said network subsequent to said receiving information on the characterization of said ringback tone is zero.

17. A protocol converter comprising:
a connection to a terminal; and
a server for sending an alerting message comprising information on the characterization of a ringback tone over a network in response to the receipt of a call over said network and for transmitting an answer signal over said network upon detecting pickup at said terminal,
wherein said information on said characterization of said ringback tone comprises information on the frequency and duration of tones and duration of pauses.

18. The protocol converter of claim 17, wherein said server enables silence suppression at least during a period of time prior to said detection of said pickup.

19. The protocol converter of claim 18, wherein said server disables silence suppression subsequent to said detection of said pickup.

20. The protocol converter of claim 17, wherein said server transmits an audio stream over said network.

21. The protocol converter of claim 20, wherein said audio stream comprises voice packets.

22. The protocol converter of claim 17, wherein said ringback tone is associated with the geographical location of said terminal.
